(19) United States
(12) Patent Application Publication
(10) Pub. No.: US 2011/0249124 A1
(43) Pub. Date: Oct. 13, 2011

(54) MONITORING SYSTEM AND METHOD

(75) Inventor: CHIEN-LIN CHEN, Tu-Cheng (TW)

(73) Assignee: HON HAI PRECISION INDUSTRY CO., LTD., Tu-Cheng (TW)

(21) Appl. No.: 12/816,343

(22) Filed: Jun. 15, 2010

(30) Foreign Application Priority Data
Apr. 13, 2010 (TW) 99111484

(51) Int. Cl. H04N 7/18

(52) U.S. Cl. 348/159; 348/143; 348/E07.091

(57) ABSTRACT

A monitoring system includes a first camera, a projector, and a processing unit. The first camera captures an object to obtain an image. The processing unit compares the image with one of a number of image patterns according to priority information of the image patterns, until finding one of a number of objects that matches the object captured by the first camera. The processing unit determines the position of the matched object to control the first camera to track the matched object. The images from the first camera are projected to a projection region by the projector.

### BACKGROUND

1. Technical Field

The present disclosure relates to a monitoring system and a monitoring method.

2. Description of Related Art

Projectors are often used by teachers or presenters to project teaching material onto a screen, however, because of this singular use, the projector is underutilized. Therefore there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a monitoring system used in a classroom, the monitoring system including a storage unit.

FIG. 2 is a block diagram of the storage unit of FIG. 2.

FIGS. 3A and 3B are flowcharts of an exemplary embodiment of a monitoring method.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

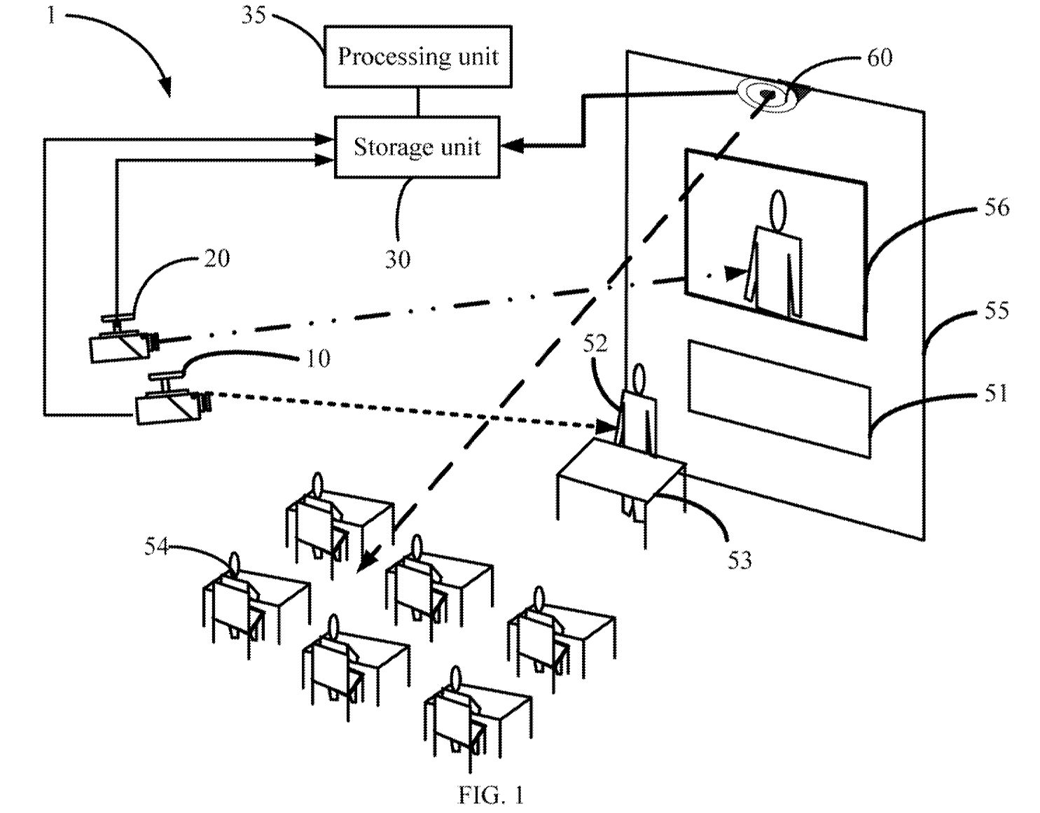

Referring to FIG. 1, an exemplary embodiment of a monitoring system 1 includes a first camera 10, a second camera 60, a projector 20, a storage unit 30, and a processing unit 35. The monitoring system 1 may be used in a group setting such as in a classroom for monitoring the classroom.

A chalkboard 51, a teacher 52, a desk 53 for the teacher 52, and a plurality of students 54 are in the classroom and are regarded as objects. The first camera 10 can be used to capture images of the objects, which are then received by the projector 20 and projected on a screen 55, to form a projection region 56. The second camera 60 captures images of the classroom and transmits the images of the classroom to the storage unit 30. The processing unit 35 accesses the images stored in the storage unit 30 and analyzes the images from the second camera 60 and determines whether an event has occurred in the classroom, such as one student 54 has a hand up to get the teacher's attention. If the student's 54 hand is up, the first camera 10 focuses on and captures an image of the student 54. In the embodiment, the first camera 10 is a Pan/Tilt/Zoom (PTZ) camera. The second camera 60 is a wide angle camera to capture the classroom.

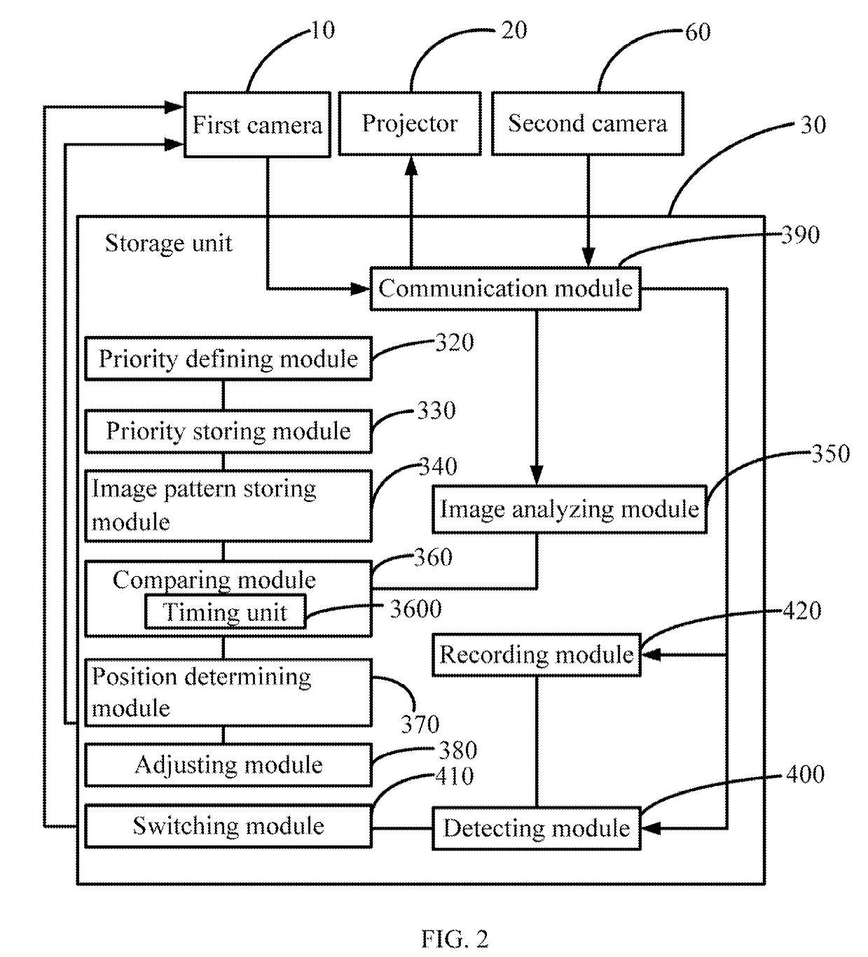

Referring to FIG. 2, the storage unit 30 includes a priority defining module 320, a priority storing module 330, an image analyzing module 350, a comparing module 360, a position determining module 370, an adjusting module 380, a communication module 390, a detecting module 400, a switching module 410, and a recording module 420 which may include one or more computerized instructions and are executed by the processing unit 35, and an image pattern storing module 340.

The communication module 390 transmits images from the first camera 10 to the projector 20 and the image analyzing module 350. The communication module 390 also transmits images from the second camera 60 to the detecting module 410 and the recording module 420.

The priority defining module 320 defines which object has a higher priority. For example, the priority defining module 320 defines the most important object, the teacher 52, as first priority, the chalkboard 51 has second priority, and the desk 53 has third priority. In other embodiments, the priority information of the objects in the classroom can be changed using the priority defining module 320.

The priority storing module 330 stores the priority information of the objects in the classroom.

The image pattern storing module 340 stores image patterns of images captured of the objects. In the embodiment, the image pattern of each image may be pixel values of the image.

The image analyzing module 350 receives an image from the first camera 10, and obtains the image pattern of the image, namely the pixel values of the image.

The comparing module 360 receives the image pattern from the image analyzing module 350, and compares the image pattern with one of the image patterns according to the order corresponding to priority information of the image patterns, until the comparing module 360 finds one of the objects corresponding to the image patterns matches the object captured by the first camera 10. For example, initially, the current image pattern is compared with a previously determined image pattern of the highest priority object, in this case the image of the teacher 52. If the current image pattern is different from the image pattern of the image of the teacher 52, the current image pattern is then compared with the image of the next highest priority object, the chalkboard 51. If the current image pattern is the same as the image pattern of the image of the teacher 52, the object which the first camera 10 captured is regarded as the teacher 52. The current image pattern of the image for the teacher 52 is stored in the image pattern storing module 340 and replaces the previous image pattern of the image of the teacher stored in the image pattern storing module 340. The teacher 52 is regarded as a matched object.

The position determining module 370 determines a position of the matched object, such as the teacher 52 in the image to obtain a position of the teacher 52 in the classroom. It can be understood the position of the teacher 52 in the classroom can be expressed by coordinates of a predetermined coordinate system.

The adjusting module 380 receives the position of the matched object, such as the teacher 52, and adjusts the first camera 10 through the use of its PTZ functions to track the matched object. For example, when the teacher 52 moves to another position in the classroom, the first camera 10 pans and/or tilts as needed to keep the teacher 52 centered in its view.

In the embodiment, the comparing module 360 also includes a timing unit 3600. The timing unit 3600 records the period or length of time comparing the image pattern from the image analyzing module 350 with an image pattern stored in the image pattern storing module 340. When the image pattern from the image analyzing module 350 is different from the image pattern stored in the image pattern storing module 340, after a preset length of time, the image pattern from the image analyzing module 350 is then compared with a subsequent image pattern stored in the image pattern storing module 340. For example, in the initial image the teacher 52 was standing at the chalkboard 310, then in the current image the teacher has moved toward the desk 53, and then in the subsequent image the teacher 52 is at the desk.

The detecting module 400 detects the images from the second camera 60 to determine whether there is an event occurring in the classroom. In the embodiment, the detecting module 400 stores an image of the classroom. The detecting module 400 compares the image from the second camera 60 with the image stored in the detecting module 400 to determine whether there is a difference between the two images. If there is a difference between the two images, an event has occurred at the position of the difference. For example, when one student 54 stands up, the image from the second camera 60 is different from the image stored in the detecting module 400. The detecting module 400 determines that an event has occurred at the position of the difference.

When an event has occurred in the classroom, the detecting module 400 outputs a detection signal according to the position of the difference to the switching module 410. The switching module 410 redirects the first camera 10 to track the object at the position of the difference. Images of the position in the classroom are transmitted to the projector 20, and are projected onto the projection region 56.

The recording module 420 records the images from the first camera 10 when an event has occurred in the classroom.

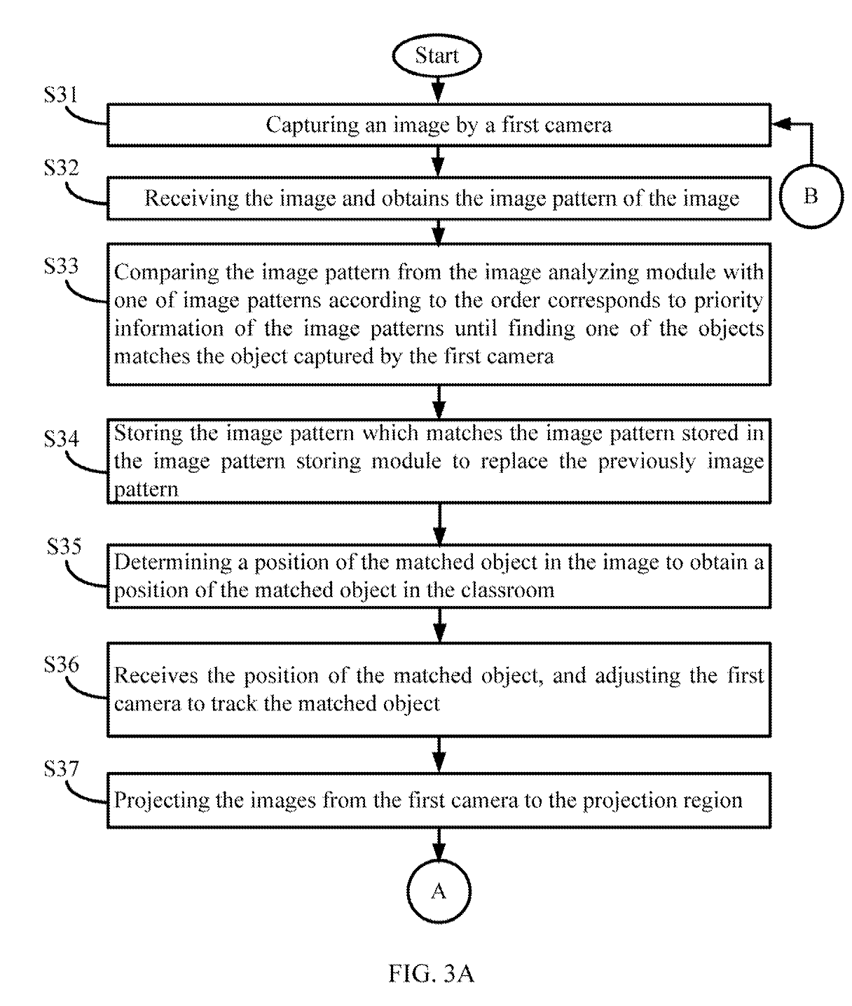

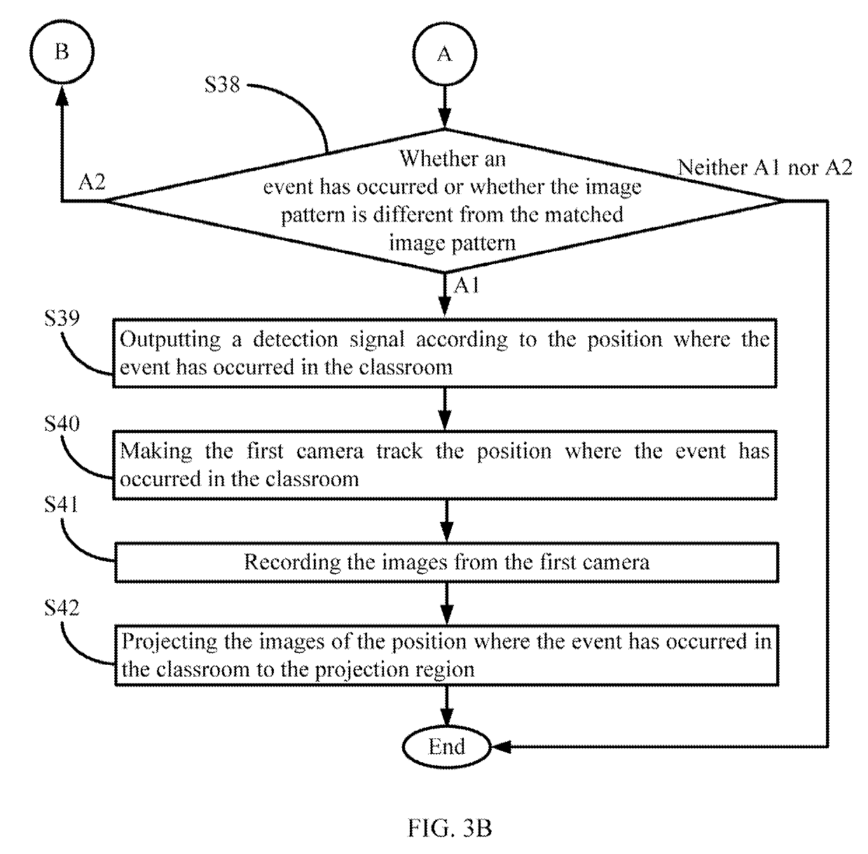

Referring to FIGS. 3A and 3B, an exemplary embodiment of a monitoring method includes the following steps.

In step S31, the first camera 10 captures an image.

In step S32, the image analyzing module 350 receives the image and obtains the image pattern of the image. It can be understood that the image pattern of the image may be pixel values of the image.

In step S33, the comparing module 360 compares the image pattern from the image analyzing module 350 with one of the image patterns stored in the pattern storing module 340 according to the order corresponding to priority information of the image patterns, until the comparing module 360 finds one of the objects corresponding to the image patterns matches the object captured by the first camera 10. For example, if the current image pattern from the image analyzing module 350 is the same as the image pattern of the image of the teacher 52 stored in pattern storing module 340, the teacher 52 is regarded as the matched object.

In step S34, the comparing module 360 stores the current image pattern in the image pattern storing module 340. The current image pattern replaces the previous image pattern of the image, such as the image pattern for the teacher 52 stored in the image pattern storing module 340.

In step S35, the position determining module 370 determines a position of the matched object, such as the teacher 52, to obtain a position of the matched object in the classroom. It can be understood the position of the matched object in the classroom can be expressed by coordinates of a predetermined coordinate system.

In step S36, the adjusting module 380 receives the position of the matched object, and adjusts the first camera 10 through the use of its PTZ functions to track the matched object. For example, when the teacher 52 moves to another position in the classroom, the first camera 10 pans and/or tilts as needed to keep the teacher 52 centered in its view.

In step S37, the projector 20 projects the images from the first camera 10 to the projection region 56.

In step S38, a determination is made whether an event has occurred in the classroom or whether an image pattern from the image analyzing module 350 is different from the current image pattern stored in the image pattern storing module 340 in step S34. If an event has occurred in the classroom, for example, if one student's 54 hand is up (marked as A1 in FIG. 3B), the process flows to step S39. If the image pattern from the image analyzing module 350 is different from the current image pattern stored in the image pattern storing module 340 in step S34 (marked as A2 in FIG. 3B), the process flows to step S31. If neither A1 or A2 is not occurring, the process ends.

In step S39, the detecting module 400 outputs a detection signal to the switching module 410 according to the position where an event is occurring in the classroom.

In step S40, the switching module 410 redirects the first camera 10 to turn to the position where the event is occurring in the classroom.

In step S41, the recording module 420 records the images from the first camera 10.

In step S42, the images of where the event is occurring in the classroom are transmitted to the projector 20, and are projected to the projection region 56.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A monitoring system comprising:
a first camera to capture a first image;
a processing unit; and
a storage unit connected to the processing unit and storing a plurality of programs to be executed by the processing unit, wherein the storage unit comprises:
a priority storing module storing priority information of a plurality of objects;
an image pattern storing module storing a plurality of image patterns of images for the plurality of objects;
an image analyzing module to receive the first image from the first camera, and obtain a current image pattern of the first image;
a comparing module to receive the current image pattern from the image analyzing module, and compare the current image pattern with one of the plurality of image patterns stored in the image pattern storing module in the order corresponding to priority information of the plurality of image patterns, until the comparing module finds one of the plurality of objects matches the object of the image captured by the first camera, wherein the one object matched the object of the image captured by the first camera is regarded as a matched object;
a position determining module to determine position information of the matched object;
an adjusting module to receive the position information of the matched object, and adjust the first camera to track the matched object; and
a projector to project the first image from the first camera to a projection region.

2. The monitoring system of claim 1, wherein the storage unit further comprises a priority defining module, the priority defining module defines priority information for each object.

3. The monitoring system of claim 1, wherein the comparing module further comprises a timing unit, the timing unit records the length of time comparing the image pattern from the image analyzing module with one image pattern stored in the image pattern storing module, upon the condition that the image pattern from the image analyzing module is different from the image pattern stored in the image pattern storing module for a preset length of time, the image pattern from the image analyzing module is then compared with another image pattern stored in the image pattern storing module.

4. The monitoring system of claim 1, wherein the image patterns of the images are pixel values.

5. The monitoring system of claim 1, further comprising a second camera to capture a second image for an area, wherein the storage unit further comprises:
a detecting module to receive the second image for determining whether an event has occurred in the area, the detecting module further outputs a detection signal according to a position where the event has occurred in the area upon the condition that an event has occurred in the area; and
a switching module to receive the detection signal, controlling the first camera to track the position where the event has occurred.

6. The monitoring system of claim 5, wherein the storage unit further comprises a recording module, the recording module records the first image from the first camera.

7. The monitoring system of claim 5, wherein the detecting module compares an original image of the area with the second image from the second camera to determine whether an event has occurred in the area.

8. A monitoring method comprising:
capturing a first image by a first camera;
obtaining an image pattern of the first image from the first camera;
comparing the image pattern with a plurality of image patterns to find one of a plurality of objects matching an object in the first image, wherein the plurality of patterns corresponds to the plurality of objects;
determining position information of the matched object;
adjusting the first camera to track the matched object; and
projecting images from the first camera to a projection region.

9. The monitoring method of claim 8, before the step of “capturing a first image by a first camera” further comprising:
defining priority information for each object.

10. The monitoring method of claim 8, wherein the step of “comparing the image pattern with one of a plurality of image patterns to find one of a plurality of objects matching an object in the first image, wherein the plurality of patterns corresponds to the plurality of objects” comprises:
comparing the image pattern with one of the plurality of image patterns according to the order in the priority information, until finding one of the plurality of objects matches the object in the first image.

11. The monitoring method of claim 10, wherein when the image pattern is compared with one of the plurality of image patterns, the monitoring method further comprises:
recording the length of time the image pattern is compared with one of the plurality of image patterns, upon the condition that the image pattern is different from the image pattern of the plurality of image patterns for a preset length of time, the image pattern is then compared with another image pattern of the plurality of image patterns.

12. The monitoring method of claim 8, after the step of “adjusting the first camera to track the matched object” further comprising:
capturing a second image for an area by a second camera;
detecting the second image from the second camera for determining whether an event has occurred in the area;
outputting a detection signal according to a position where the event has occurred in the area upon the condition that an event has occurred in the area; and
receiving the detection signal to control the first camera to track the position where the event has occurred.

13. The monitoring method of claim 12, after the step of “receiving the detection signal to control the first camera to track the position where the event has occurred” further comprising:
recording the first image from the first camera.

14. The monitoring method of claim 12, wherein the step of “detecting the second image from the second camera for determining whether an event has occurred in the area” comprises:
comparing an original image of the area with the second image from the second camera to determine whether an event has occurred in the area.
